(19) United States
(12) Patent Application Publication
(10) Pub. No.: US 2011/0313870 A1
(43) Pub. Date: Dec. 22, 2011

(54) Initiating and Enabling Secure Contactless Transactions and Services with a Mobile Device

(75) Inventors: Richard Eicher, Windham, NH (US); Richard Eicher, JR., Windham, NH (US)

(73) Assignee: Skycore LLC,, Boston, MA (US)

(21) Appl. No.: 12/902,720

(22) Filed: Oct. 12, 2010

Related U.S. Application Data
(60) Provisional application No. 61/250,975, filed on Oct. 13, 2009.
(60) Provisional application No. 61/324,492, filed on Apr. 15, 2010.

(51) Int. Cl. G06Q 30/00

(52) U.S. Cl. 705/16

(57) ABSTRACT

A system and method for a mobile device to initiate and enable contactless transactions and services between a user of said device and remote servers controlled by a service administrator. Such device will have an application or other facility residing it for reading data embedded in an object. The present invention provides for the loading of one or more service profiles to such mobile device based on certain unique identifiers of the user, such as a PIN or username and password, along with the unique ID of the mobile device itself or an administrator-assigned ID. Such service profiles are stored on such mobile device with a unique service ID and a unique service URL for such mobile device to transmit and receive data, along with certain unique identifiers, in real-time and in a secure, closed-loop environment.

### RELATED US PATENT DOCUMENTS

This application claims priority of the following provisional US Patent Applications:

| Application Number | Filing Date |
|---|---|
| 6,125,0975 | Oct. 13, 2009 |
| 6,132,4492 | Apr. 15, 2010 |

### REFERENCES CITED

U.S. Patent Documents

| | | |
|---|---|---|
| 6,045,043 | April 2000 | Bashan et al. |
| 6,282,522 | August 2001 | Davis et al. |
| 6,345,263 | February 2002 | Matsumoto et al. |
| 6,480,101 | November 2002 | Kelly et al. |
| 6,538,558 | March 2003 | Sakazume et al. |
| 6,560,581 | May 2003 | Fox et al. |
| 6,629,080 | September 2003 | Kolls |
| 6,636,833 | Oct. 21, 2003 | Flitcroft et al. |
| 6,873,974 | March 2005 | Schutzer |
| 7,058,414 | June 2006 | Rofheart et al. |
| 7,136,835 | November 2006 | Flitcroft et al. |
| 7,287,271 | October 2007 | Riggins |
| 7,376,839 | May 2008 | Carta et al. |
| 7,587,756 | September 2009 | Peart et al. |
| 7,644,265 | January 2010 | Kudo et al. |

### REFERENCE TO SEQUENCE LISTING, A TABLE, OR A COMPUTER PROGRAM LISTING COMPACT DISK APPENDIX

Not Applicable

### REFERENCE TO FEDERALLY SPONSORED RESEARCH OR DEVELOPMENT

Not Applicable

### OTHER REFERENCES

1. “Transaction.” InvestorWords.com. 14 Mar. 2010. <http://www.investorwords.com/5046/transaction.html>.

2. “Web services.” SearchSOA.com. 14 Mar. 2010. <http://searchsoa.techtarget.com/sDefinition/0,,sid26_gci750567,00.html>.

3. OR Code Features. 2010. QR Code.com. 20 Mar. 2010. <http://www.denso-wave.com/qrcode/qrfeature-e.html>.

4. “Maximum URL length is 2,083 characters in Internet Explorer.” 27 Oct. 2007. Microsoft Support. 14 Mar. 2010. <http://support.microsoft.com/kb/208427>.

5. HTTP Client Methods—GET and POST. 2010. Web Developers Notes. 20 Mar. 2010. <http://www.webdevelopersnotes.com/basics/http_client_methods_get_post.php3>.

6. How credit cards work. 2010. CreditCards.com. 20 Mar. 2010. <http://www.creditcards.com/credit-card-news/how-credit-cards-work-1268.php.

7. What is an IMEI? 2010. GSM Security. 12 Mar. 2010. <http://www.gsm-security.net/faq/imei-international-mobile-equipment-identity-gsm.shtml>.

### DESCRIPTION

1. Field of the Invention

The present invention relates generally to the initiation and enablement of transactions or services through the use of a mobile device and, more particularly, to methods for secure real-time data transfer between a mobile device and remote servers and back-end systems in conducting such transactions or services.

2. Background of the Invention

Current systems and methods to initiate and enable contactless transactions have one or more limitations which affect the appeal of these systems to consumers, to enterprises, to Point of Service (POS) providers and to transaction fulfillment providers, among others.

In the case of contactless transactions involving payments, adoption of contactless payment technology by POS providers has been very limited. The current systems, if any, at the POS to enable such transactions generally utilize only one contactless transaction technology, such as NFC, RFID or POS-managed barcode readers. This restricts the number of POS locations a consumer can use any one technology they have available to them while correspondingly reducing interest from POS providers to install such systems, especially if they need to install multiple systems, each one representing a different contactless transaction technology. Further, the smaller the number of POS locations at which a consumer can conduct such transactions, the lower the incentive for consumers to adopt any single technology. Because of such limitations, adoption will likely continue to be limited and fragmented for a number of years.

What is necessary and disclosed herein is a novel contactless payment technology which could be more readily implemented than those currently available and to enable consumers to select this technology or other payment technologies, all from their mobile device, depending on which technology is offered by the POS.

Furthermore, with the compliance requirements of the PCI DSS (Payment Card Industry Data Security Standard) becoming increasingly more complex, time consuming and expensive, what is necessary and disclosed herein is a method to avoid completely or, at a minimum, reduce the need for such compliance by initiating and enabling transactions without the on-device storing or wireless transmission of personally identifiable information or of credit card, debit card or other confidential transaction information.

In the case of contactless transactions that provide for the secure transfer or exchange of information in real time between enterprise and employee or between enterprise and consumer, for example in an access control application or for coupon redemption at retail, or the transfer or exchange within the enterprise itself, for example in an inventory control application, the current systems and methods are generally expensive and require substantial overhead to manage.

What is necessary and disclosed herein are systems and methods to drive down the costs and overhead for such information transfer using secure, real-time transaction technologies. In particular, one embodiment of the present invention envisions facilitating secure, real-time contactless transactions using virtually any mobile device which has the capability to read objects embedded with data, thus reducing the demand for specialized, low volume hardware and systems for completing the same. Further, those skilled in the field will enable new capabilities and services, including such services as lead retrieval at exhibitions and contest validations in real-time.

### SUMMARY OF INVENTION

The present invention provides systems and methods and a combination of systems and methods to initiate and enable contactless transactions. Such invention intends to increase consumer interest in conducting contactless transactions; to improve the return on investment for POS providers to install contactless transaction systems; to enable transaction fulfillment providers to more broadly offer their products and services using contactless transaction technology; to enable new, real-time tracking and validation services; and to drive down the costs and overhead for the exchange of information between enterprise and employee and enterprise and consumer and within an enterprise itself.

The invention discloses the use of a mobile device which has the capability to read one or more types of data-embedded objects in contactless transaction systems and methods associated with how they may process such data embedded in such objects, append additional data, in particular unique identifiers of the mobile device user and/or the mobile device itself, and post the resulting string of data to remote servers.

In particular, the invention details systems and methods and combinations of systems and methods to initiate and enable secure, real-time transactions between a mobile device and remote servers; for unique identifiers of the mobile device user and mobile device itself to trigger the loading of permissions-based service profiles of remote services to the device; and the use of HTTP POST method for transmitting such data to and from the mobile device to remote servers in real-time and receiving a response without the delays associated with opening a browser. The end result is a closed-loop system created and controlled by their respective system administrators for secure, real-time transactions and transfer of data between parties, with or without any intermediary parties.

Such system embodies a method for initiating a contactless transaction and selecting a service profile through a process involving data-embedded objects and mobile devices able to read such objects; a method by which a contactless transaction can be facilitated through use of such readers capable of reading a plurality of objects depending on the contactless technology presented; a method by which a transaction is initiated or a service is selected through the submission of unique identifiers of the reader's user and/or the reader itself to a remote server; a method by which the transaction or service is enabled or facilitated in real-time between an object reader and the server hosting a particular service; a method by which an object reader is verified; and a method disclosing a processing by which the transaction or service is consummated using the system of the present invention.

One of the many novel features of the current invention is enabling the user of an object reader to choose the type of data-embedded object to read if such object reader is so enabled. Such choice can be advantageous to POS providers in that they would not necessarily be tied to a single vendor, centralized server or a single technology for the initiation and enabling of contactless transactions. Said provider would have a choice of vendors and technologies based on that which best suites their objectives for price and performance.

Another advantage of the present invention is that the user of the system of the invention can initiate and enable several transactions and services, each with individual permissions and features, using their object reader. In particular, to initiate a transaction or to access a service, the user of an object reader is required to enter unique user identification, such as a PIN or username and password, and optionally, an access code. Entering such information bestows the user of the object reader a plurality of services or transaction fulfillment methods available to the particular user and mobile device.

A preferred embodiment of present invention discloses the use of two dimensional (2D) barcodes to initiate and enable contactless transactions. The majority of mobile phones on the market currently include digital cameras and the operating systems of such phones have the capability to add or come pre-loaded with 2D barcode reading applications. Add to that the ease of creating such barcodes and the low or negligible cost for presenting them and it stands to reason that such 2D technology has a low barrier for entry for enabling contactless payment transactions for consumers and that enterprises can capture significant savings for enterprise applications by using commonly available mobile devices, such as mobile phones, for contactless transactions and services instead of the far more expensive industrial scanners currently in use. The present invention discloses in detail the systems and methods for secure, closed-loop transactions to be conducted in real-time using 2D barcodes.

Embodiments of the invention provide a facility for enabling the selection of transaction types and services which appear on the user interface of the object reader. In payment transactions, for example, consumers may choose from a multitude of payment accounts, rather than being limited to access to or use of a single credit or debit account. Such consumer becomes an active participant in initiating and enabling a transaction and, importantly, related services such as coupon savings or loyalty rewards. These embodiments may employ one or more of the following features disclosed herein either singly or in combination. Moreover, these embodiments may be facilitated with past, present, and emerging technologies.

The foregoing, and other features and advantages of the invention, will be apparent from the following, more particular description of the preferred embodiments of the invention and the accompanying drawings. Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

To better understand the invention and to realize how the same may be carried out in practice, some preferred embodiments will now be described, by way of non-limiting example only, with reference to the accompanying drawings, in which:

FIG. 1 is an exemplary block diagram of a system in which the present invention may be implemented.

FIG. 2 is a diagram illustrating an example implementation of the present invention;

FIG. 3 illustrates the detailed architecture of the Data Manager in accordance with one embodiment of the present invention;

FIG. 4 illustrates a Reader that displays the Object types it is capable of reading;

FIG. 5A illustrates the loading of service profiles, based on a Reader user's and Reader's unique identifiers, through a series of Posts between the Reader and Data Manager;

FIG. 5B illustrates the process of activating (authorizing) and deactivating (de-authorizing) services through a series of Posts between the Reader and Data Manager;

FIG. 6 is a figure illustrating two possible Objects envisioned in the system of the present invention and system;

FIGS. 7A illustrates a possible technique for validating an Object;

FIG. 7B illustrates a system for appending Object data to service URLs;

FIG. 8 is a flow chart illustrating the steps taken in using the system of the present invention in a payment processing transaction;

FIG. 9A illustrates an example implementation of the system of the present invention in a financial transaction environment;

FIG. 9B is a diagram of another example implementation of the system in an Event Access Control application.

### DETAILED DESCRIPTION

In order to promote an understanding of the principles of the invention, reference will now be made to the exemplary embodiments illustrated in the drawings, and descriptive language will be used to detail the same. It will nevertheless be understood that no limitation of the scope of the invention is thereby intended. Any alterations and further modifications of the inventive features manifested herein, and any additional applications of the principles of the invention as depicted herein, which would occur to one skilled in the art, with relevant expertise and having possession of this ingenuity, are to be considered within the breadth of the invention.

The disclosures herein relate generally to a method and system for initiating and enabling secure contactless transactions, such as the use of like method and system by a consumer for transactions with a merchant, whether online or physically within an establishment, and services, such as the use of like method and system by an enterprise to enable access control or asset tracking. In particular, the system provides for a multitude of applications to securely read, track, record and verify information embedded in Objects in real-time.

The term Object, as used herein, shall refer to barcodes, images (or other Multipurpose Internet Mail Extensions (MIME) types), Near Field Communications (NFC) devices, Radio Frequency Identification (RFID) tags and other wireless communications technologies which generally have data embedded in them, with such data able to be wirelessly discerned, captured or decoded, as necessary, by a mobile transmission receiving device, mobile scanning device or other mobile device, each a ‘Reader’ as used herein, without necessarily making direct contact with such Object (hence, “contactless”). The term transaction as used herein, refers not only to its commonplace meaning as the consummation of, or attempted consummation of, an agreement between a buyer and seller to exchange an asset for payment¹ but also to the transfer or exchange of information between parties enabling such activities as recording, inspecting, correlating or verifying such information to achieve a specific purpose.

One facet of the invention is to take advantage of mobile devices which, as Readers, contain pre-installed or post-installed Object reading capabilities or include peripherals which enable them to do so, such as those designed to provide NFC two-way communication, RFID read/write and contactless payment capability for the mobile device. Additionally, the invention is contemplated as being used in any generic transaction or service. In that regard, as used herein, transaction, service, and similar terms are intended to include such transactions or services whereby such mobile devices are used to control access to a particular place such as a building, concert venue, or transportation system; pay for goods or services through an online or local merchant; track assets; or trigger a multimedia service or event.

While the descriptions of the appended figures will portray the preferred iteration of this invention as being employed with 2D barcodes, this has been provided by way of example and not as a limitation to the scope or spirit of the invention, rather for purposes of brevity. The invention may be utilized through one-dimensional (1D) and 2D images or for other Objects with embedded data capable of being read by a mobile device.

Moreover, it will be understood that while the description may reference specific types of contactless technologies and Readers, this is only provided by means of example. The system is designed to be universal in that a user, POS provider, and application provider would not be tied to a single vendor or a single technology for contactless transactions and therefore has a choice of vendors and technologies based on that which best suits their objectives, such as best price and performance.

Note that although the following discussion of the present invention focuses on the use of the invention in contactless transaction and service applications, it may be found advantageous in other types of environments as well, and likewise is not so limited. Specifically, the system of the present invention is contemplated as also being useful in settings whereby the initiation of a service or a transaction with a Reader may occur in the absence of an Object. An example of such is enabling entry to an automobile or premises through selection of such service as one of the services available on the Reader. More particularly, the invention is envisioned as enabling an all or many-in-one type system whereby all or many of the user's transactions, services, and the like, made available on the Reader through the loading of such through the systems and methods of the present invention, may be initiated and enabled using one Reader in one place, regardless of the technology standard, transaction type, or service classification.

It is readily apparent to one skilled in the art that additional functions can be added to the process and functions modified or removed and still be within the spirit and scope of the invention.

Embodiments of the invention will now be described with reference to the accompanying figures.

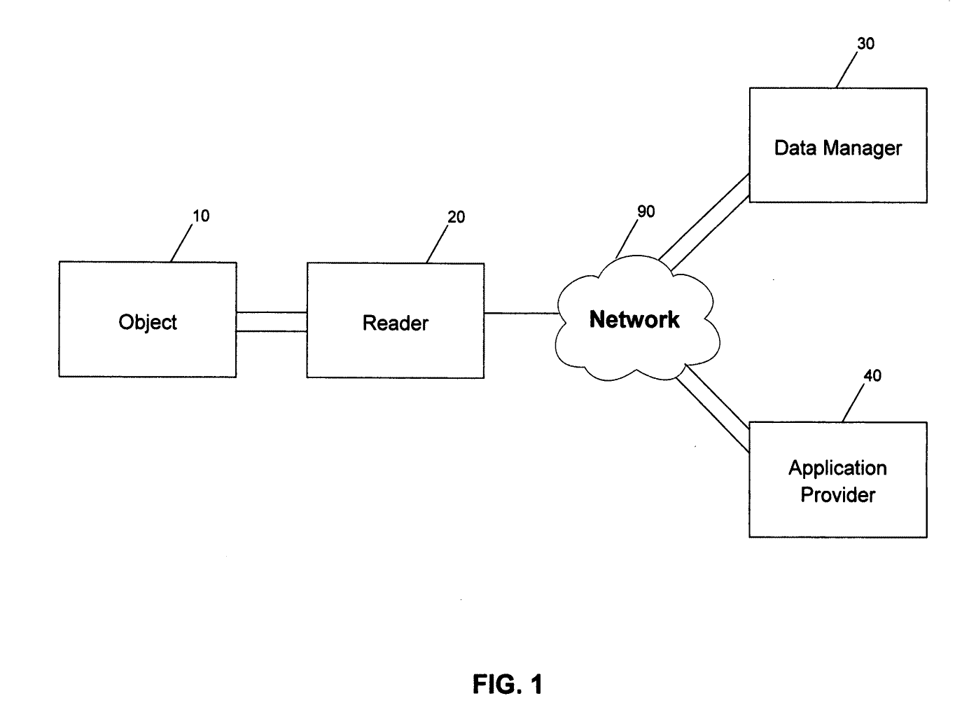

FIG. 1 shows an exemplary block diagram of one embodiment of a system, in which the present invention may be implemented. FIG. 1 illustrates a system in which a Reader 20 initiates and enables a contactless transaction.

System includes at least one Reader 20, at least one Object 10, at least one Data Manager 30 server, at least one Application Provider 40 server, and at least one communication Network 90 that provides communication between the Reader 20 and the Data Manager 30 and Application Provider 40. In actuality, such a system can include a plurality of Objects 10, Readers 20, Data Managers 30 and Application Providers 40, but for simplicity sake, just one of each is shown in FIG. 1. Object 10 is typically a 1D or 2D barcode, image, NFC device, or device utilizing RFID, however, the embodiment is not so limited. The Object 10 may take the form of paper, a smart card or other digital circuit, or a digital rendering that may appear on a POS monitor or other digital screen at the POS (a ‘Transaction Presenter’), on a desktop computer or even on a mobile device, but the embodiment is not so limited.

A Reader 20 is typically a wireless mobile device, such as a smart-phone, which generally includes input devices, such as a keypad, and output devices, such as a display and digital camera. Additionally, the Reader 20 may contain external accessories that enable the Reader 20, for example, to read RFID and NFC communications. The Reader 20 is not forced to come into immediate proximity with the Object to establish communication. Preferably, the Reader 20 is not limited to one mode of communication but combines short range, proximity and contact communication to take advantage of the mode most appropriate to a given situation. Mobile devices using such operating systems as iPhone, Android, Blackberry, Symbian, Microsoft, Linux, BREW, or J2ME are envisioned as being utilized in the present invention. Additionally, intelligent mobile scanner devices, such those made by manufacturers Motorola, Honeywell, Psion, Intermec, Data Logic, Opticon, Denso and similar suppliers, may also be utilized in the present invention, providing such devices have the capabilities necessary to perform the described functions of the present invention. However, the embodiment is not so limited. Any mobile device or scanner device that provides the capability to perform the described functions may be used with the present invention.

The Reader 20 contemplated in this invention is envisioned as possessing the ability in one embodiment to conduct a significant amount of transaction processing on the Reader 20 itself, including initiating, tracking, and verifying transactions relating to multiple Objects, each with its own unique identifier, and periodically Posting an update of such processing results to the Data Manager 30. In another embodiment, the Reader 20 enables processing of said transactions in real-time by decoding the data embedded in an Object, and subsequently individually Posting that data to the Data Manager 30 for the Data Manager 30 to track such transaction or service, verify such transaction or service, consummate such transaction or service, and the like.

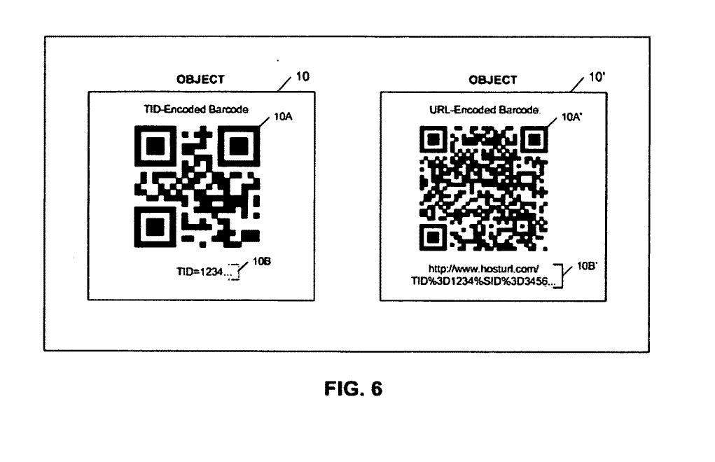

Additionally, the Reader 20 is conceived as including a display, such as an LCD or other display type that is capable of providing visible indicia to the user of such a device. The display may be a combined input and output device, such as a touch screen display, which is capable of providing outputs to a user as well as receiving inputs from users. In an exemplary embodiment a user can pass or wave their Reader 20 over a Transaction Identifier (TID) Encoded barcode, like that illustrated in FIG. 6, to read the information embedded in such TID-Encoded barcode. Where required, the user may interact with the Reader 20 to initiate discerning of the Object 10 via any input device or user interface, such as, a keypad, keyboard, mouse, and the like.

When an Object 10 is within range of a Reader 20, the Reader 20 can interrogate the Object 10 to obtain the data embedded in such Object and may optionally use cryptographic protocols to encrypt the TID and any other data to be transmitted, to provide additional security. The cryptographic protocols maintain data confidentiality, integrity, and authentication.

System may include one or more Data Manager 30. The Data Manager 30 provides services to the Reader(s) 20 and Application Provider(s) 40 and allows users to store data in one central location. The Data Manager 30, in particular, is responsible for the management of all data/information of a particular application or service. Such includes data administration, the standards for defining data and the way in which people perceive and use it. Moreover, it is notable that some of the functions herein described in respect to the Data Manager 30 may all be performed by the Data Manager 30 or in part by the Data Manager 30 and Application Provider 40.

The Data Manager 30 and Application Provider 40 may additionally perform any of the functions typically performed by web services² or provide the interfaces necessary for third party service providers to perform such web services through an applications programming interface (API) or through PostBack URLs, wherein such third party servers receive and transmit transaction and service data, whether directly between the Reader 20 and the third party servers or through the Data Manager 30 or Application Provider 40.

System may include one or more Application Provider 40. An Application Provider 40 handles application operations between users and back-end applications or databases. Application Provider 40 is typically used for complex transaction-based applications and may be either application-specific or universal, as the invention is contemplated as being utilized in a variety of applications and industries.

The Network 90 across which the information transfer occurs may include any configuration of mobile and non-mobile networks. Moreover, the Network 90 may include both public networks, such as the Internet, and private networks and may utilize any networking technology and protocol. The present invention contemplates any and all possible configurations of such a Network 90.

Although the communications links between Object 10 and Reader 20, between Reader 20 and Data Manager 30, and between Data Manager 30 and Application Provider 40 may be unencrypted, it is preferred that these communications links, and any others that may exist, depending upon the configurations of the networks involved, be encrypted to provide security for private, personal, or proprietary information that may be transmitted.

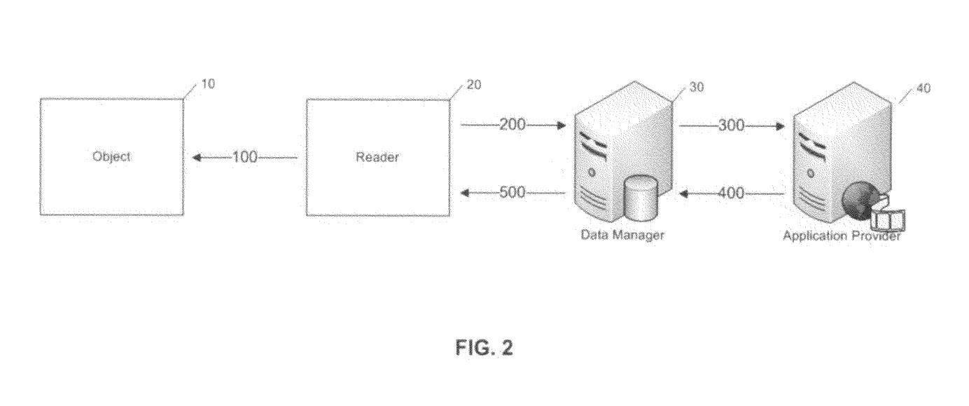

FIG. 2 refers to the invention in more detail, herein disclosing the process of initiating, enabling, processing, validating and consummation of a contactless transaction. FIG. 2 illustrates the various steps involved in conducting the system of the present invention. In this embodiment, the user can initiate and enable a transaction through the use of a Reader 20. One step of the embodiment is the user initiating a transaction by reading 100 an Object's 10 embedded data through use of their Reader 20. A variety of techniques may be used to permit the user to initiate a transaction. Example illustrative techniques are shown in subsequent figures.

Another step of this embodiment is enabling the transaction to be facilitated by processing such information obtained from the Object 10. It is notable that the process of initiating or enabling a transaction occurs through a series of Posts 200, 300, 400 and 500 between the Reader 20, the Data Manager 30, and Application Provider 40.

The preferred method for form data submission between Reader 20 and Data Manager 30 is HTTP POST method⁵, herein alternatively referred to as Post method, Post, Posted, Posting and the like. The Post method is the preferred method in the present invention for a number of important reasons, including, among others, the ability to send lengthy form data such as transactional data, user data and Reader 20 identification, whether encrypted or not; the ability to submit non-ASCII characters; and the ability to make form data less visible.

In the present invention, different strings of data may Post 200 from a Reader 20 to a Data Manager 30 to achieve specific results. Those strings may include, among others, a string in the form of unique identifiers, which on receipt by the Data Manager 30, initiates the Posting 500 of all available and authorized services to the Reader 20; another string of unique identifiers to initiate the authorization of services available for the Reader 20 but not yet authorized for the Reader 20 or Reader 20 user; another string representing the values of the data scanned or read by the Reader 20, submitted along with any associated data appended from data stored on the Reader 20, or entered by the user; and another string representing the data processed by the Data Manager 30 and Posted 500 to the Reader 20.

Unique identifiers may consist of all or any combination of such identifiers as username, password, access code, personal identification number (PIN), Reader 20 ID and mobile phone number. In a typical embodiment, the username and password identifies to the Data Manager 30 the user of the Reader 20, whereas the Reader 20 ID identifies to the Data Manager 30 the Reader 20 to which and from which data is Posted.

The access code may be used as a separate, unique identifier meant to serve functions beyond that of a typical username and password. In one embodiment, the Post 200 of a username and password to the Data Manager 30 could identify the user of the Reader 20. The separate entry of an access code could trigger adding that Reader's 20 unique ID to that Post, consequently enabling that Reader 20 to be authorized for one or more services by the Data Manager 30. Importantly, in this way, the administrator of the Data Manager 30 can separately track, manage and administer Reader 20 users from the Reader's 20 unique ID. It is envisioned, that for certain applications, the same username and password may be used by multiple users where, in such cases, a manager or administrator could use access codes to enable or disable select services or Readers 20 while present or remote from Reader 20. Example illustrative techniques are shown in subsequent figures.

Processing of data may be accomplished locally through a database on the Reader 20, or processing may occur together with a Data Manager 30 and/or Application Provider 40 in Posts 200 and 300, respectively. If the transaction is processed on the Reader 20, periodic updates between the local database on the Reader 20 and the Data Manager 30 and/or the Application Provider 40 may be required.

A further step of this embodiment is the validation of the data embedded in the Object 10 and, optionally, the confirmation of receipt of such data from an authenticated Reader 20. Validation and confirmation of either may occur at the Data Manager 30 or alternatively at the Application Provider 40 which securely Posts 400 the resulting data indicating validation and confirmation, or lack thereof, to the Data Manager 30.

Yet another step of this embodiment is Posting 500 the status of the transaction to the Reader 20. This may take the form of notification of the status for admittance to an event or the status of a payment transaction for the purchase of goods or services, but the embodiment is not so limited. The specific nature of these embodiments will be disclosed in substantial detail in the figures dissertated below.

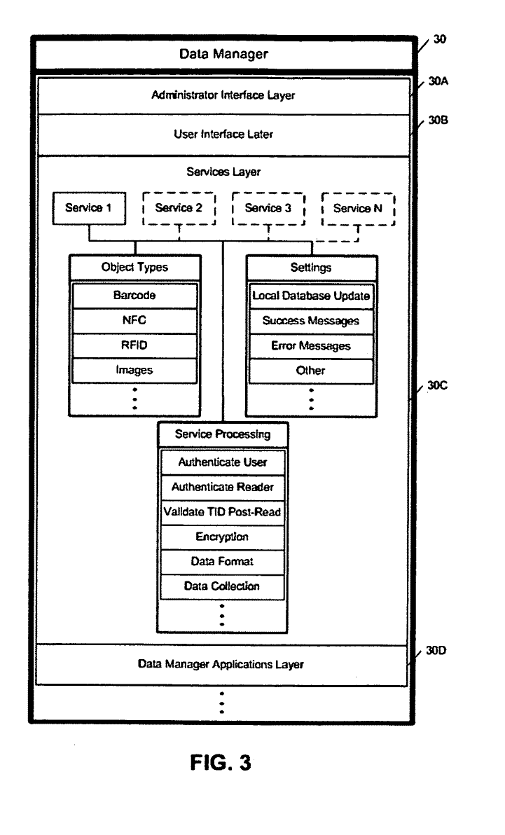

FIG. 3 illustrates the structure of the Data Manager 30 in an embodiment of the present invention. The Data Manager 30 enables Application Providers to transmit, store, manage and receive data for each service the user or application provider creates. Moreover, the Data Manager 30 provides for storing, accessing, and tracking data residing in one or more said data repositories. In some cases the Data Manager 30 services database might be held locally on the Reader itself, in addition to on a specific host server, or alternatively may be accommodated exclusively on the specific host server. Many applications may require the ability to download information from an information repository and operate on this information even when out of range or disconnected, making having a local database in addition to a global database desirable.

For example, in some ticket validation applications it may be preferable to have the ticket database on the Reader 20 itself, due to wireless connectivity or real-time redemption issues. In such cases, the ticket database may be downloaded to the user's specific application or local database of the Reader. To prevent duplicate redemption of like ticket numbers, the info from the Readers themselves are periodically transmitted from their database to a designated server. Such transmission updates the main database and subsequently the main database updates the Reader's database. In fact, such a method can be found to be useful in environments where multiple ticket redemption devices are being used. The time period upon which the database may be updated is configured by the event administrator, for example every 5 minutes. This approach allows the Data Manager 30 to be easily scaled from a low-end client-only system to a large, high-end globally distributed, enterprise wide data management system.

The Data Manager 30 allows users and administrators of services to create and customize their accounts. Once the user of the Reader, or an administrator of multiple Readers and services, has set up their account and uploaded their preferences, they are ready to manage their account and the services associated with it. It should be noted that, in addressing the need for initiating and enabling a secure contactless transaction, in the preferred embodiment no personal information the user entered through the Data Manager 30, including payment card numbers, whether directly by the user or through an administrator of services, will be stored on a user's Reader. Rather each service associated with a user or group of users, in some cases, is given a unique service identification number (SID). Since it is designed for use with one of more services, the Data Manager 30 permits the user or administrator to make global configuration changes for their associated services or alternatively implement changes on an individual service basis.

The Data Manager 30 is additionally responsible for Posting to the Reader the services and associated permissions based upon the submission of the Reader user's unique identifiers, such as username, password, PIN, unique Reader ID or access code. All data transfers between a Reader and the Data Manager 30 occurs through the Post method.

Returning to FIG. 3, our preferred embodiment contemplates the use of several layers which comprise the architecture of the Data Manager 30. Spanning one of these layers is the Administrator Interface Layer 30A. The Administrator Interface Layer 30A provides all features necessary to properly maintain the data for a particular application. This includes controlling the importing and exporting of the data and managing lists of slots and time intervals data will be imported or exported from the database. Additionally, the Administrator Interface Layer 30A allows the administrator to specify the elements for the Data Manager 30 to interact locally in a user-only environment or alternatively an administrator-only environment.

Occupying another layer of the Data Manager 30 is the User Interface Layer 30B. A user interface system is provided with a graphical user interface for enabling a user to interact with one or more services provided by the Data Manager, allowing easy and convenient access to all of the services from the users prospective. Restrictions placed on the amount of information viewable and editable is set by an administrator through the Administrator Interface Layer 30A. One skilled in the art could easily envision how the User Interface Layer 30B can employ several methods such as, but not restricted to, wrappers, shell scripts, batch files, command line interfaces, graphical user interfaces, web browsers, or menus, which would be customized to the user's environment or methodology. The advantage of this approach is it allows different methodologies or processes to utilize the same underlying Data Manager 30.

Under the Administrator Interface Layer 30A, the administrator is given the ability to add and modify the services offered for the particular user under the Services Layer 30C. As shown in the figure, under the Services Layer 30C, the administrator can modify such items as the accepted Object types, various user and/or administrator settings, and the steps involved in the redemption process; but the embodiment is not so limited. For example, the administrator may wish to modify the authentication process for high speed, low security transactions. Moreover, the administrator is given the ability to set the designated update times between the Reader's local database and the Data Manager 30.

The organization structure of our system illustrates how single data management architecture can be used to adapt to virtually any methodology or process. Adaptation of the data management system to a user environment is accomplished through a single architectural layer. This allows the architectural core, including all transactions and functions encompassed therein to remain methodology and environmentally independent. Although the aforementioned references only the administrator being given the capability of adjusting the settings for a particular application, the user, if given permission, may do so through the User Interface Layer 30B of the Data Manager 30. Administrator updates implement changes globally, whereas any alterations made through the User Interface Layer 30B are user specific.

The Data Manager 30 may also consist of a Data Manager Applications Layer 30D, which contains all of the standard utilities that an administrator or user needs in order to interact with the Data Manager 30 and for the Data Manager 30 to communicate with Application Providers. This includes things like creating and tracking an aggregation or configuration, and setting or viewing process results. Those skilled in the art will recognize that the Data Manager 30 may consist of any other number of layers.

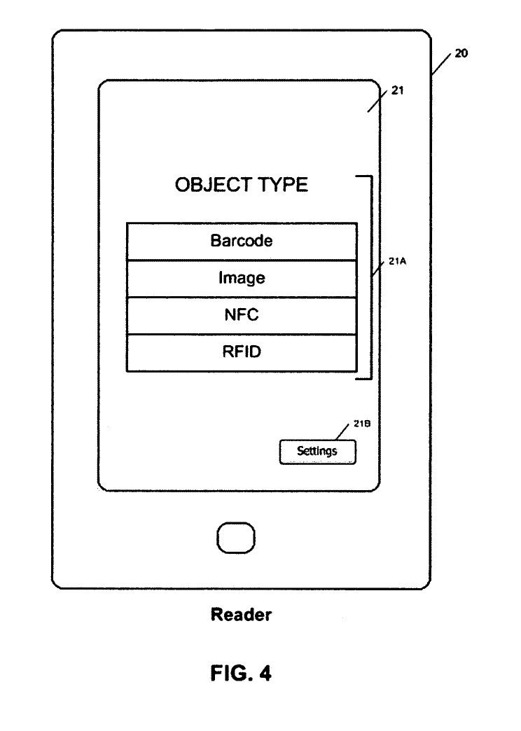

FIG. 4 illustrates a Reader 20 that displays an Object Type 21A list with typical Objects shown that the Reader 20 user can select from. The major advantage of using a list of technologies displayed on the user interface 21 of the Reader 20 is that the user is allowed to select the Object Type 21A they wish to read to initiate and enable the transaction. Specifically, the user, by selecting the type of Object to be read, allows the Reader 20 to anticipate and configure itself for the type of reading to be performed. Moreover, the user can adjust the Settings 21B of their Reader 20 if need be. This is important since the operation range and security features will not be the same for all contactless technologies. For example, to use NFC services, the user needs to touch the service tag or other NFC device with the detection area. For such technology the user may need to adjust sensitivity of the detection range. When the tag is recognized, the corresponding information is displayed on the Reader's 20 user interface 21.

Those skilled in the art of contactless reader technology have previously been locked in the mindset that a contactless reader is only capable of reading a single or a very limited list of contactless technologies. Allowing a Reader 20 to anticipate and configure itself for the type of Object to be read adds to the universality of the invention for initiating and enabling contactless transactions through an array of contactless technologies. While the aforementioned description refers to the Object being selected by the user, the system of the present invention contemplates this as being an automated or semi-automated process.

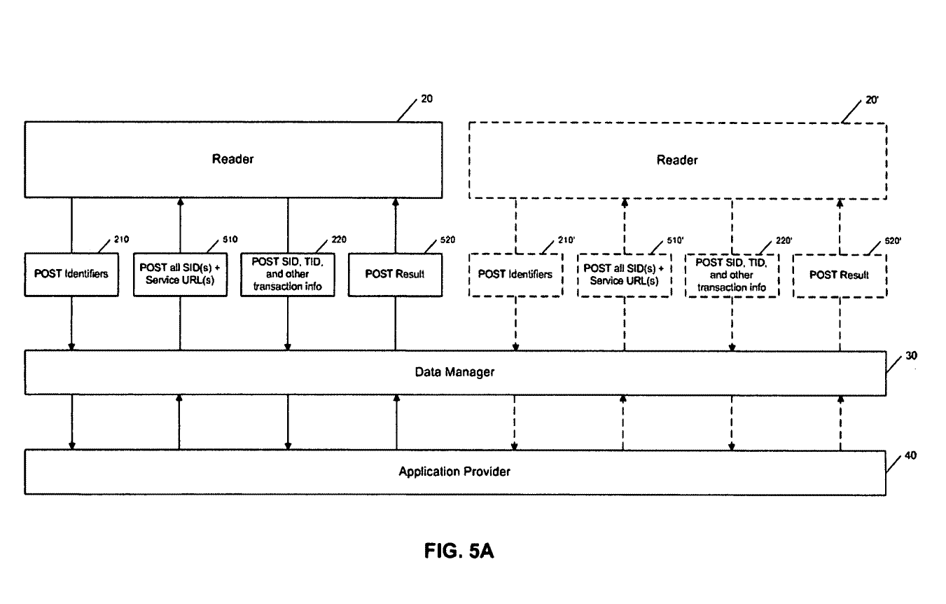

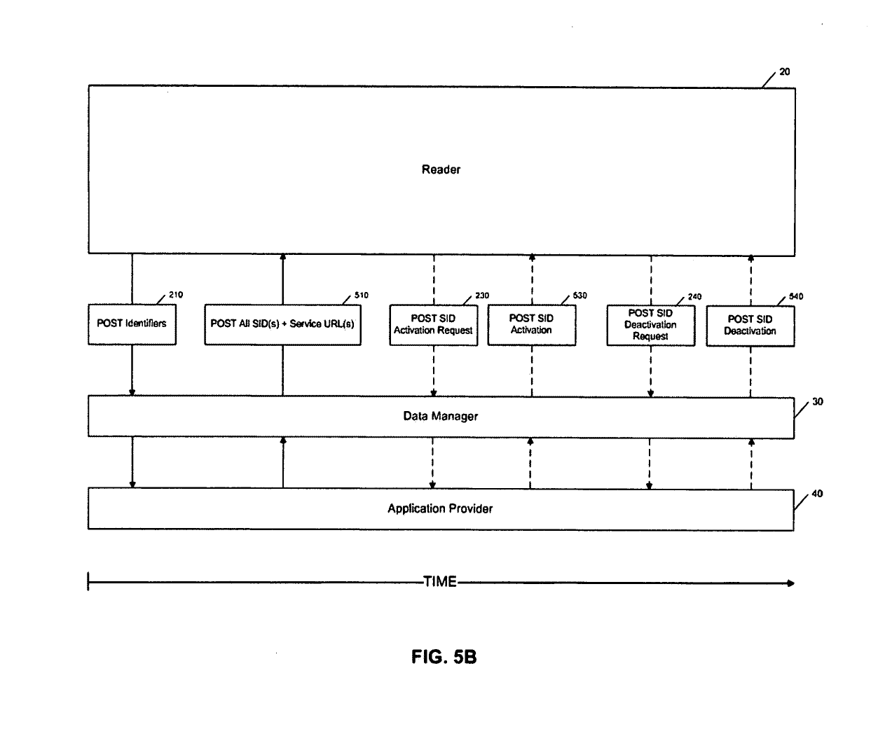

FIG. 5A is a flow diagram illustrating the steps involved in Posting data from the Reader 20 to the Data Manager 30 and optionally to the Application Provider 40, in accordance with one embodiment of the present invention.

To initiate data transfer between the Reader 20 and the Data Manager 30, the Reader 20 Posts 210 unique identifiers representing the Reader 20 and Reader 20 user to the Data Manager 30. Such initial Posts 210 are directed to a specific location on the Data Manager's 30 server, with such location derived from a URL, hereinafter referred to as the ‘base URL’, stored on the Reader 20. Such base URL is generally defined and controlled by the Data Manager 30 or Application Provider 40 and may be hard-coded in the Reader 20 or variable, depending on the application, but in all cases available on the Reader 20 or to the Reader 20 user prior to the initial Posts to the Data Manager 30.

If those Posted 210 identifiers match the authorized identifiers residing on the Data Manager 30, the Data Manager 30 will then authenticate the Reader 20 and user and Post 510 to the Reader 20 one or more SID and service URL corresponding to the permissions for said Reader 20 and Reader 20 user.

If more than one service has been Posted 510 to the Reader 20, the user of the Reader 20 selects a service. Once a service is selected, the user may begin scanning TID-Encoded barcodes. In the preferred embodiment of this invention, the Reader 20 will Post 220 to the Data Manager 30 the values embedded in each scanned TID-Encoded barcode along with associated data stored on the Reader 20, such as the Reader 20 ID, the SID or any other data that may be associated with the service, Reader 20 user or Reader 20.

Since the service URL normally corresponds to a URL address located on the Data Manager 30 server, the Data Manager 30 then parses the data from the Post to record, correlate and optionally validate the data received from each Reader 20 scanning for the same SID. The Data Manager 30 then Posts 520 the data processing results to the Reader 20 from which it received the original Post 220.

In another embodiment, when Posting 520 to the Reader 20 the Data Manager 30 may also transfer to the Reader 20 a database of TIDs associated with a particular SID. In this embodiment, once the user begins scanning TID-Encoded barcodes, the scanned TID values are checked against the TID values in the corresponding on-Reader 20 service database and the on-Reader 20 service database is modified accordingly. The portion or ‘batch’ of the database that has been modified, or, in some cases, the entire database, is then Posted 220 to the Data Manager 30, using the service URL, along with other data, such as the Reader 20 ID, the SID or any other data that may be associated with the service, user or Reader 20. The Data Manager 30 then processes this batch data and Posts 520 the processed data to each Reader 20 actively scanning TID-Encoded barcodes for the same service. This batch processing and associated posts are meant to continue until scanning is no longer required for that service.

In certain embodiments the Data Manager 30 may transfer data Posted from the Reader 20 to an Application Provider 40 for processing. In other embodiments, the Data Manager 30 and Application Provider 40 may be one in the same entity.

FIG. 5B illustrates another embodiment of the present invention whereby both authorized and unauthorized service profiles are loaded to a Reader 20 and subsequently unauthorized services are authorized through the use of access codes. In particular, FIG. 5B depicts with respect to a time how access codes can be used to authorize and de-authorize a service.

As prior disclosed in FIG.5A, service profiles, including SID(s) and associated service URL(s) are loaded to a Reader 20 through Posts from the Data Manager 30. Such services are Posted after certain unique identifiers are Posted to and confirmed as authentic by the Data Manager 30. In this embodiment, an access code is not used for the initial loading of services to the Reader 20 since it is reserved for a special function.

Some service profiles loaded to the Reader 20 may or may not be authorized for use by certain Reader 20 users or Readers 20 based on the particular unique identifiers originally Posted 210 to the Data Manager 30. Services which are unauthorized are so because of restrictions placed on specific services by the user or administrator of those services. In such cases those services must be authorized prior to use. One method to accomplish this is through the use of alphanumeric access codes. It is contemplated in this invention that unauthorized services which are Posted 510 to the Reader 20 will, unlike authorized services, not have an indicator next to them in the Reader's 20 user interface listing of available services.

If the user wishes to authorize an unauthorized service, the user must select the service from the Reader's 20 user interface, upon which the user is prompted to enter an access code. Once entered, the access code is Posted 230 to the Data Manager 30 along with the SID and other unique identifiers representing the Reader 20 and Reader 20 user. If the access code and the associated identifiers match that which is stored in the Data Manager 30, the entity will store like information in their database and Post a string of data 530 to the Reader 20 to authorize that service and such service will subsequently be shown on the Reader's 20 user interface as active. The access code can be allocated to provide temporary access to the Reader 20 for the particular service for a designated period of time or, alternatively be a firm access code, allowing the Reader 20 access every time the Reader 20 is used for this particular service.

Alternatively, if the Reader's 20 user wishes to de-authorize an authorized service, the Reader's 20 user must select that service from the Reader's 20 user interface, upon which the user may again be prompted to enter an access code. The access code, once entered, is Posted 240 to the Data Manager 30 along with other unique identifiers representing the Reader 20 and Reader 20 user. If the access code and the associated identifiers match that which is stored in the Data Manager 30 or Application Provider 40, then the entity will store like information in their database and Post 540 a data string to de-authorize the service on the Reader 20 and such service will subsequently be displayed on the Reader's 20 user interface as unauthorized. The user or administrator of services can reactivate the particular service by submitting the same or another access code, like that in the aforementioned authorization steps. Like the authorization access code prior discussed, the de-authorization access code can act as a temporary or permanent disablement of the particular service.

FIG. 6 illustrates Object 10 in two implementations suitable for the present invention, in this case Quick Response® codes (QR codes), a certain type of 2D barcode. This type of Object may be read, for example, by positioning a Reader capable of reading a QR code in front of the QR code. QR codes are an appropriate encoding technology for the purposes of the present invention as they provide good fault tolerance and easy re-digitization of the embedded data.³

Two example implementations for QR codes pertaining to this invention are illustrated in this figure. One is a TID-Encoded Barcode 10A and the other a Uniform Resource Locator (URL) Encoded Barcode 10A′. The TID-Encoded Barcode 10A is envisioned as consisting of a unique TID 10B. The URL-Encoded Barcode 10A′, alternatively, is contemplated as comprising of an identification string of data appended to a URL of a host server. This identification string may consist of the TID 10B′, a Service Identifier (SID), and any other relevant information to the transaction. Moreover, the identification string can be of any length, so long as it does not exceed the maximum URL length permitted by the web browser used, since the string is to be appended to a said URL. The said URL may be hosted by the Data Manager, Application Provider or a third party source.

The preferred embodiment of this invention utilizes a TID-Encoded Barcode 10A because it is more secure and flexible, as previously detailed, for both users and application providers. In this method, the TID 10B and other identifiers are not Posted by the Reader to the Data Manager using the URL embedded in the QR code. Instead, the URLs used for Posting such data and identifiers are the unique service URLs stored on the Reader as a result of the methods detailed in FIG. 5A.

However, in at least one embodiment, the Reader may not need or otherwise have the capability to store service URLs for accessing services as herein contemplated. In those cases, an alternative method would be to use URL-Encoded Barcodes 10A′, or other Objects with URLs embedded in them, depending on the situation.

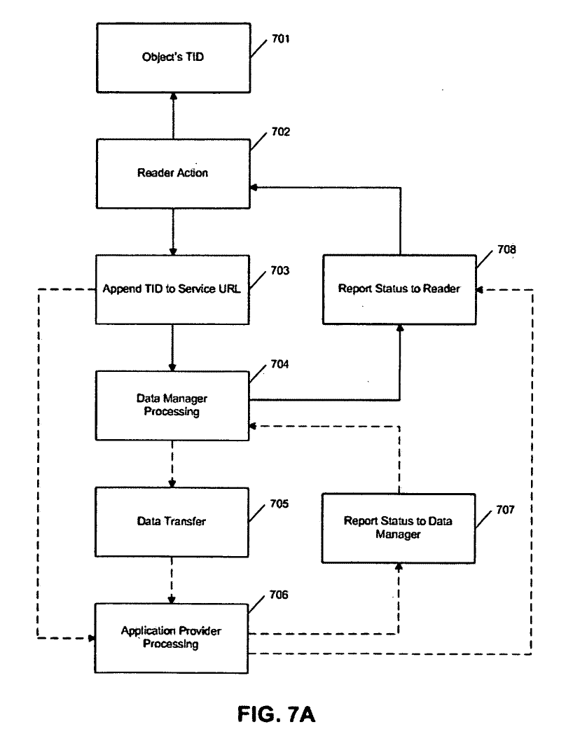

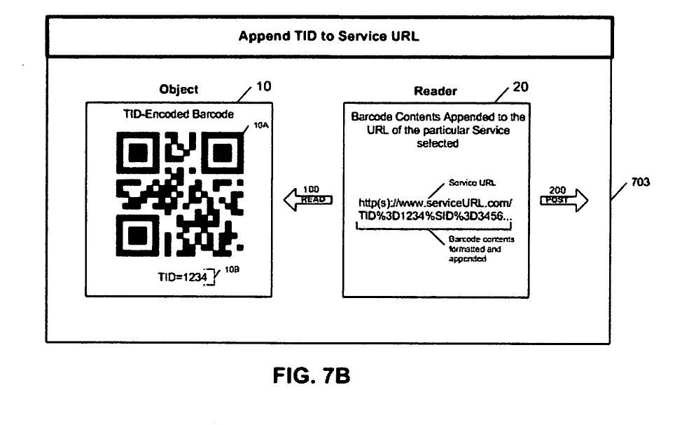

FIG. 7A illustrates possible techniques to validate data embedded in an Object. Specifically, FIG. 7A exhibits an embodiment of the invention in which the data embedded in an Object are validated by the Data Manager and an alternate embodiment where it is validated by the Application Provider. Such figure assumes the Reader's user has already Posted their unique identifiers to the Data Manager and have accordingly received the Post of available SIDs and service URLs from the Data Manager or Application Provider, as shown in FIG. 5A.

As prior mentioned, entry of a username, password, and optional access code may be used to Post a list of the Reader user's available services. The services furnished to the user on the screen of their Reader, as prior mentioned, represent a list of the user's available services, each with an associated SID and URL unique to that particular service. Upon selection of a specific service, the SID, and in some cases the Reader's device ID, must be validated in order for the service or transaction to be enabled. In certain instances, an Application Provider may desire to have the Data Manager handle all of the services associated with the validation process, for reasons such as convenience. In other instances, however, the Application Provider may be inclined to administer the validation process on their own or authorize such services to be handled by a third party entity, such as a trusted services manager, for example, in order that they may have more control over the validation process.

Returning back to FIG. 7A, the method of validation begins at a step 701, where the Reader, after the user has selected a particular service, reads the Object which is embedded with information relevant to a particular transaction or service. The Reader then, in a step 702, parses the information embedded in the Object and isolates its unique identifier, also referred to as a TID. Based on the service configuration set by the user of the Reader or the administrator of services, as disclosed in FIG. 3, the Reader will take certain actions. One such action may be encrypting the Object's TID, in a step 703, and appending it to the selected service URL. Another possible action is appending the Reader's ID to the said service URL.

Detailed in FIG. 7B is an example of a TID 10B appended to a URL, an integral part of step 703 shown in FIG. 7A. Each loaded service profile has its own service URL to direct Posts to a specific URL located on the Data Manager or other remote server. As shown in FIG. 7B, the TID 10B embedded and subsequently initiating a transaction by reading 100 from a TID-Encoded Barcode 10A is appended to the selected service's service URL by the Reader 20 and then Posted 200 to the Data Manager. Another possible action is appending the Reader's 20 unique ID to the said service URL.

Returning back to FIG. 7A, also in step 703, before Posting the information obtained from reading the Object to the Data Manager or Application Provider, the Reader's user may be asked to enter additional information. This information may be specific questions or data entry fields requested by the Data Manager or Application Provider or, alternatively, may be additional measures for more securely executing a transaction, such as through additional security codes.

Moreover, in a step 703, the information required in the validation process, including that which was acquired in prior portions of a step 703, is appended to the selected service's URL. Subsequently a Post is initiated, as in the preferred embodiment, or alternatively, a browser may be launched so as to transmit the entire data string to the pertinent handler designated by the service URL.

As demonstrated in the figure, there are many methods by which the verification process can be completed. Note that multiple Posts may occur between the Reader, Data Manager, and/or the Application Provider. For example, the service URL of the particular service may be that of the Data Manager; however the Data Manager may associate the particular service with a service URL of the Application Provider, and thus perform validation in a multi-step, multi-post process.

One contemplated method of this embodiment is the Data Manager, in a step 704, handling the entire verification process. This involves the Data Manager receiving a data string from the information rendered from the Object and Reader in a step 703, checking to see if a corresponding database resides on the server; correlating the received data with the corresponding database residing on the server; parsing out the data; executing the transaction or initiating the service; and subsequently forwarding the results of the transaction or service to the Reader in a step 708. Moreover, in such an embodiment, it is envisioned that the Data Manager may track the use of a particular service based on the unique identifiers of the user or through the identification number of Reader.

Another possible method of this embodiment is the Application Provider, in a step 706, facilitating the entire verification process. This setup, like the previous one described, involves the Application Provider receiving a data string from the information rendered from the Object and Reader in a step 703, checking to see if a corresponding database resides on the server; correlating the received data with the corresponding database residing on the server; parsing out the data; executing the transaction or initiating the service; and subsequently forwarding the results of the transaction or service to the Reader in a step 708. Moreover, in such an embodiment, it is envisioned that the Application Provider may track the use of a particular service based on the unique identifiers of the user or through the identification number of Reader.

Yet another potential method of this embodiment is the Data Manager and Application Provider working in conjunction with one another, in handling the verification process. In one possible implementation, the Data Manager receives data from the Reader, in a step 704, and subsequently forwards like information to the Application Provider through a data transfer, in a step 705. Such data transfer can be achieved in a Local Area Network, Wide Area Network, or a globally distributed environment such as the internet. The Data Manager, moreover, may forward as much or as little information to the Application Provider, as is necessary, for the particular transaction or service completion.

At the Application Provider, in a step 706, the data received may be decrypted and the relevant data parsed out. Further, in this step, the Application Provider, from the data received, actuates whether the Object is valid, and if so, enables the transaction. Following this step, the Application Provider transmits a result in a step 707 to the Data Manager. The Data Manager, accordingly, may choose whether or not to store such a result in the system. The Data Manager may then forward the result to the Reader in a step 708. At this point, the Reader's user is notified as to the success or failure of the transaction, or the enablement of a service. Moreover, in such an embodiment, it is envisioned that the Data Manager and/or the Application Provider may track the use of a particular service based on the unique identifiers of the user or through the identification number of Reader.

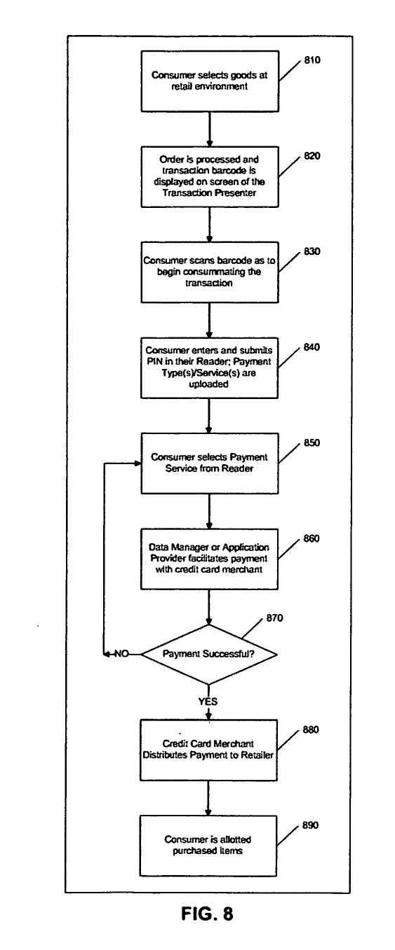

FIG. 8 illustrates an example implementation of the system in a physical retail environment or an online shopping environment. In particular, FIG. 8 illustrates how the system of the present invention would be advantageous as an alternative method for a consumer to pay for goods or services in such retail environments.

Non-cash modes of payment are being used more and more frequently for the payment of products and/or services at the POS. Retailers, banks and a host of financial institutions are providing consumers with a multitude of different payment cards for this purpose. Currently consumers must carry these payment cards with them when they shop, exposing them to the potential for lost or stolen cards. The present invention as disclosed herein provides a more secure and flexible alternative to consumers physically carrying around payment cards.

In physical retail environments or online shopping environments, the consumer is accustomed to having the retailer facilitate the payment for purchasing goods using the consumer's credit, debit, gift or other payment card. In a physical retail environment, the most common method involves the consumer swiping their payment card across a magnetic stripe reader or, in some countries, tapping their credit card against a card reader.⁶ In an online shopping environment, on the other hand, the retailer normally requires the shopper fill out a payment form. By bestowing such information to the retailer, the consumer's privacy may be hindered, as such methods provide the retailer with a lot of information about the consumer, including the holds on a particular pin, the amount the consumer has been authorized to spend, and card usage.

The system of the present invention seeks to avoid such a step and provide added convenience by allowing the consumer to purchase goods and services in a retail environment and initiate and enable payment to the retailer themselves through a Reader, as defined herein.

Additionally, our method allows a consumer to use the system of the present invention as a sophisticated mobile wallet. Specifically, in being utilized as a mobile wallet, the present invention can be found to be more secure than traditional approaches, as it addresses the major issue of identity and payment card theft resulting from lost or stolen wallets. It's been reported by the Federal Trade Commission that, “1 in 6 Americans will be a victim of identity theft this year [2010] alone. In the last twelve months 9.93 million people have had some type of identity theft crime committed against them. Victims spend on average $1,200 in out-of-pocket expenses and an average of 175 hours in [their] efforts to resolve the many problems caused by identity thieves.”

When using the system of the present invention, no personal identifying information pertaining to the consumer is stored on the Reader, unless they so choose to do so. If the Reader were to be lost or stolen and the consumer was worried about someone else using their payment cards and other services associated with their Reader, all the consumer would have to do is report their Reader's identification number, such as IMEI or UDID, to their Data Manager, and/or Application Provider, depending on who their payment services provider is, saving countless hours of frustration.

Returning to FIG. 8, in a step 810, the consumer determines the product(s) and/or service(s) to purchase. Moreover, in a step 810, the consumer brings the product(s) which they wish to purchase to a register, if in a physical retail environment, or else a virtual checkout, if the selection of the items was made online. For ease of description herein, any reference to a product is also applicable to a service and vice versa.

In a step 820, the order is processed at the register or online checkout. Upon completion of processing the order, a barcode, for example, is displayed to the consumer on the screen of the Transaction Presenter. The Transaction Presenter may be either a register's monitor or other digital display device at the physical retail environment or it may be the consumer's digital display device used for internet access if the transaction was initiated online. Moreover, the Transaction Presenting can include not only point of sale terminals and payment card processing devices, such as those offered by VeriFone, but also devices such as notebook computers, netbook computers, palmtop computers, personal data assistants (PDA's), personal computers (PC), network computer (NC), and the like.

The barcode furnished may consist of such information as purchase data, retailer routing number, and the register number upon which the transaction was consummated; but the embodiment is not so limited. Moreover, the barcode may take the form of a TID encoded or URL encoded barcode. Moreover, the barcode may be presented in either 1D or 2D form. However, 2D barcodes are more appropriate for this type of transaction, as they provide increased security and additional storage capacity.

Next, in a step 830, the consumer scans the barcode with their Reader to begin consummating the transaction. The Reader, subsequent to scanning the barcode, may store the barcode as an image file or a bitmap in its memory; it then may read the barcode from its memory, so as to consummate the transaction. Such a method may be desirable if the consumer wishes to confidentially store their transaction details. Alternatively, the Reader may discern the barcode without storing it in memory. In either method, the contents of the barcode are decoded and subsequently various payment options may be automatically shown. The contents of the barcode data object may be like that illustrated in FIG. 6, but the embodiment is not so limited. The preferred embodiment of the invention utilizes TID Encoded barcodes; however, the use of URL barcodes may also work in the example illustrated in this figure.

In a step 840, the consumer enters unique identifiers in the Reader and submits them to the Data Manager and/or Application Provider via POST in order to load their service profiles. For financial transactions, the unique identifiers may include, but are not limited to, a username and password or PIN, access code and unique Reader ID. The PIN which the consumer must enter is envisioned as being like that currently provided for payment card's, a four digit secret number or code given to the consumer at the time of issuance for the purpose of security. Like the payment card PIN, using a particular payment type/service on the Reader is valueless without the PIN. Moreover, the PIN, when Posted with the Reader's unique Reader ID, can be used to load all service profiles, for example, or may be used to load a single service profile. The unique identifiers, in sum, define the services which are available to the consumer.

Additionally, in a step 840, subsequent to the consumer entering their unique identifiers or PIN on the Reader, such identifiers and the unique Reader ID of the Reader itself are appended to a base URL, stored on the Reader, and Posted to the Data Manager and/or Application Provider for verification and loading of service profiles. Submission of the unique Reader ID to the Data Manager and/or Application Provider can be found as advantageous in highly secure transactions, like that illustrated in this figure.

Readers, as contemplated in this invention, may have a unique ID issued by the Data Manager or may be embedded with a unique device ID, both herein referred to as a Reader ID. A unique device ID could be, for instance, a Unique Device Identifier (UDID) for Apple's iPhone devices or International Mobile Equipment Identity (IMEI) number for BlackBerry devices, by means of which the respective device can be identified in telecommunication and other networks. Such ID's are unique to every device and used by network providers to identify valid devices and therefore can be used to stop a stolen phone from accessing a particular network.⁷ If a user's Reader is stolen, for example, the owner can call his or her network provider and instruct them to disable a phone using its IMEI number. With an IMEI number, the phone can be blocked from the network quickly and easily. Additionally, use of an IMEI or the like is particularly suitable for use in the present invention since an IMEI is only used to identify the device and does not relate to a specific individual or organization, protecting an individual's personal information. In this invention it is also contemplated that the Application Provider or account administrator will be able to receive lost or stolen device identification numbers from the user and subsequently place restrictions or holds on the particular account, but the embodiment is not so limited.

Moreover, in a step 840, service profiles representing the consumer's payment cards are loaded to the Reader via the Post method from the Data Manager and/or Application Provider. These services typically represent the various payment cards the consumer has stored on the Data Manager or Application Provider servers unique to their username, password, access code PIN or Reader ID. Each service, in the preferred embodiment of the invention, is Posted with a unique URL directed to the Data Manager or Application Provider server.

Next, in a step 850, the consumer selects a particular payment service from the Reader. Such payment providers may include the likes of MasterCard, Visa, American Express; banking institution's cards and other payment facilities, such as debiting checking and savings accounts; and retail merchants own credit, debit, gift, loyalty and other types of transaction accounts. As prior mentioned, each payment service, as configured by the consumer or provider, in some cases may require its own unique PIN in order to be allowed full use, over limits for example. Such configurations may be set or edited at the Data Manager, as illustrated in FIG. 3.

In a step 860, the Data Manager or Application Provider facilitates payment based on the service selected by the consumer in a step 850. Subsequent to selection of the desired service, the transaction data is forwarded by the Data Manager or Application Provider to the payment provider to pay the debt. In addition to the transaction data, additional data about the type of payment are preferably added to the payment record, for example charging to a particular card number, debiting a particular customer account, debiting a particular bank account, or debiting from a prepaid monetary amount stored in the Reader, for example on the SIM card of the Reader.

Next, in a step 870, it is actuated by the payment provider whether the disbursement of funds was successful. The payment provider may authorize or deny the consumer's request for payment of their selected goods or services. If successful, then the method moves onto a step 880 where payment is distributed to the retailer so as to pay for the consumer's selected goods. Otherwise, payment is denied, and the customer is accordingly notified. If payment is deemed unsuccessful, the consumer may select an alternate payment service from their list of authorized services or choose to add one. Alternatively the consumer may choose to end the transaction, whereby the consumer is denied receipt of their selected goods.

Next, in a final step 890, the consumer is allotted the goods which they selected in a step 810, or initiates delivery of such items, if the purchase was made online. Just as in conventional local retail environments where the state of the transaction is promulgated to the consumer and/or clerk on some sort of output device, such as an LCD display on a register, the present invention envisions the assent of the transaction to be disclosed to the consumer on the Transaction Presenter.

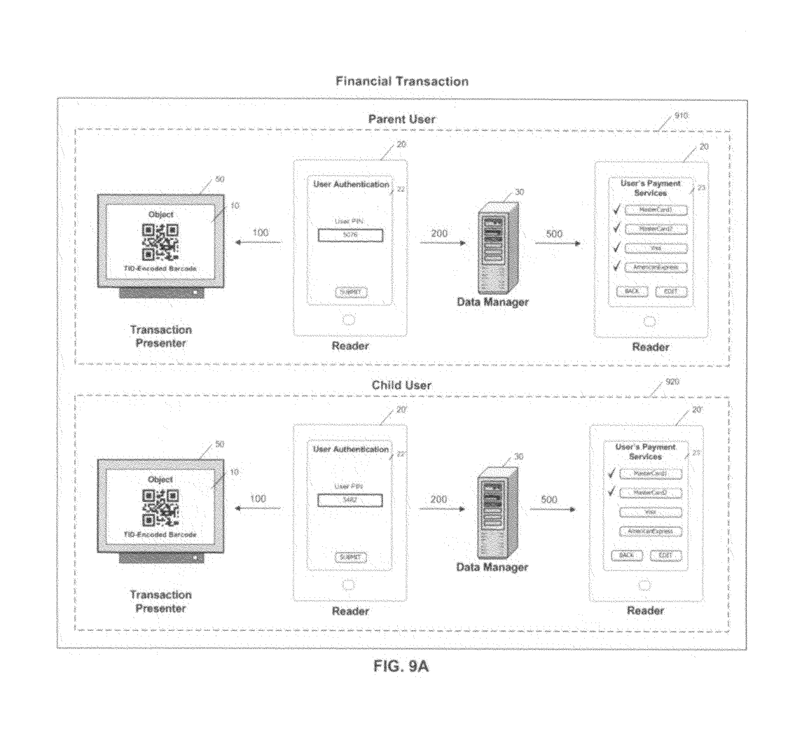

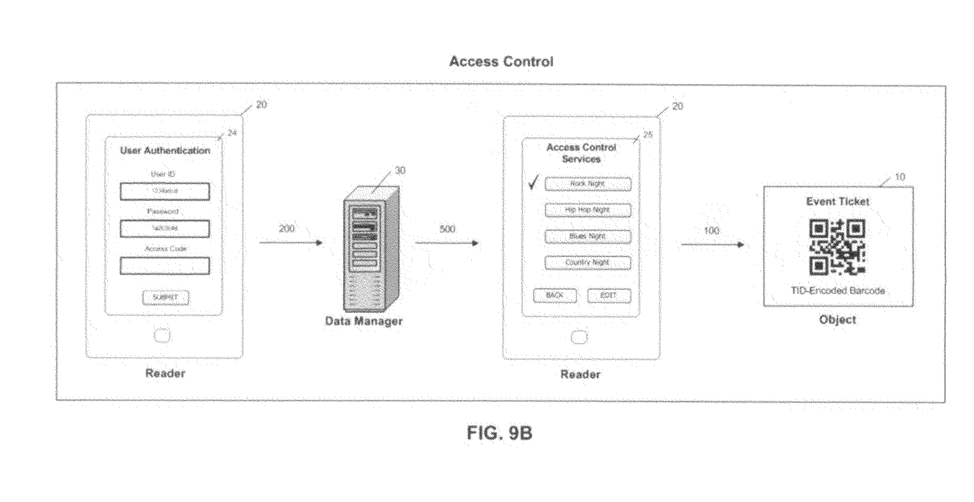

FIGS. 9A and 9B illustrate two embodiments of the present invention, both indicating the methods for loading service profiles to a Reader 20 but each in a different order relative to the reading of an Object; whereas FIG. 9A indicates the reading of an Object occurring before the loading of relevant service profiles to a Reader 20, FIG. 9B indicates the reading of an Object occurring after the loading of relevant service profiles to a Reader 20.

FIG. 9A refers to the services necessary for a user, generally a consumer, for financial transactions whereas FIG. 9B refers to the utilization of services by a user, generally an enterprise employee, for access control at, for example, a venue requiring a valid ticket for entry. These are but a few of many possible implementations.

In particular, FIG. 9A illustrates how the system might be useful to a parent who wishes to provide a child with access to their payment accounts administered through the Data Manager 30, however, with restrictions such as transaction restrictions and limits on use. Using the system of the present invention, parents may do so through use of unique PINs for Parent User 910 and Child User 920 and by separately activating certain services by unique Reader 20 ID on the parent's Reader 20 and certain services on the child's Reader 20′.

Referring to FIG. 9A, an advantage of the present invention, as prior disclosed, is that a user of a Reader 20 can select from several services and initiate a variety of secure transactions from their Reader 20. Shown in User's Payment Services 23 and User's Payment Services 23′ are the same services but two different service statuses. This is a result of the Data Manager 30, when Posting 500 such services to Readers 20 and 20′, correlating the different user PINs entered 22 and 22′on the Readers 20 and 20′, respectively, and the different Reader 20 ID's of Reader's 20 and 20′ with the service permissions for such PINs and Reader 20 IDs.

There are many possible variations possible with the present invention. For example, a parent could create totally separate accounts and services for their child; or share accounts with the child but only allow the Posting of activated services; or share all accounts but only activate one or more. In this example, the parent has shared all accounts but only allowed activation for a limited number of services. The benefit to this sharing method is the parent only has to maintain one account with the Data Manager 30 and at the parent's convenience they may activate and deactivate services for emergency use by the child or to further restrict access.

Additionally, the parent could share their PIN with the child, thereby having only the unique Reader 20 ID to define which service profiles are loaded. However, this may not be in the most secure method or a parent may not want to share their PIN with the child so in this example the PINs entered for User's Authentication 22 and User's Authentication 22′ are different.

Returning to FIG. 9A, the Reader's 20 User's Payment Service's 23 for the Parent User 910 represents, in this example, the services available to the parent, while the Reader's 20′ User's Payment Services 23′ of Child User 920 denote the services available to the child of the parent.

In this figure, the Parent User 910 and Child User 920 each consummate their own, separate transactions. For either to consummate their transaction, they may initiating a transaction by reading 100 a TID-Encoded barcode Object 10 off a Transaction Presenter 50 at a point of service. Subsequently they are each prompted by their Readers 20 and 20′ to enter a unique identifier, in this case the PIN unique to each user.

For Parent User 910, the PIN and the Reader's 20 unique Reader 20 ID along with the parsed TID are appended to a base URL stored on the Reader 20 and Posted 200 to the Data Manager 30. This base URL points to a specific location on the Data Manager's 30 server. The Data Manager 30 will then independently authenticate each PIN and Reader 20 ID, providing they match those on its database, correlate the TID with a type of service, in the case of payment services, and then Post 500 those services to Reader 20 as authorized for said PIN and unique Reader 20 ID.

Similarly for Child User 920, the PIN and the Reader's 20′ unique Reader 20 ID along with the parsed TID are appended to a base URL stored on the Reader 20′ and Posted 200 to the Data Manager 30. This base URL points to a specific location on the Data Manager's 30 server. The Data Manager 30 will then independently authenticate each PIN and Reader 20 ID, providing they match those on its database, correlate the TID with a type of service, in the case of payment services, and then Post 500 those services to Reader 20′ as authorized for said PIN and unique Reader 20 ID.

This figure illustrates the parent's User's Payment Services 23 indicating, here with a check mark, authorization to use all payment services while the child's User's Payment Services 23′ indicate both active (authorized) and inactive (unauthorized) payment services, here with and without a check mark, respectively. As described in FIG. 5B, one embodiment of the present invention details the use of access codes for enabling inactive services to become active services. Following that method here, the child's User's Payment Services 23′ which are not active, perhaps because the parent withheld such codes to the child, could become active in emergency cases, for example, where the parent could disclose the access code to the child and subsequently change it as desired.

FIG. 9B illustrates an alternate implementation of the system as might be used in an Access Control application, such as that used for an event access control. In this or similar enterprise applications, such as asset tracking, the Reader's 20 user would generally need the service profiles relevant to the task at hand loaded to the Reader 20 before reading Objects, in this example a TID-Encoded Barcode 10A.

Referring to FIG. 9B, the Reader's 20 user enters their unique (or shared, in some cases) username and password on the Reader's 20 User Authentication 24 form. Such username and password and the Reader's 20 unique Reader 20 ID are then appended to a base URL stored on the Reader 20 and Posted 200 to the Data Manager 30. This base URL points to a specific location on the Data Manager's 30 server. The Data Manager 30 will then independently authenticate the username and password and Reader 20 ID, providing they match those on its database, and then Post 500 certain Access Control Services 25 to Reader 20 based on the said username, password and unique Reader 20 ID.

Access Control Services 25 which are activated (authorized for use) are highlighted by checkmarks. Notice that only a subset of the Access Control Services 25 Posted are activated. Accordingly, the Reader 20 user may only select marked services to begin reading TID-Encoded barcode 10A. If the Reader 20 user, for instance, tried to initiating a transaction by reading 100 tickets for events they are not authorized for the Reader 20 would not allow the user to do so.

To obtain access to the inactivated Access Control Services 25, which are not highlighted by checkmarks, the Reader 20 user, or, for some applications, the employee's manager, may select the desired inactivated service and enter an appropriate access code to activate that service.

In the Access Control example, subsequent to the selection of a service, for example Rock Night, the user of the Reader 20 will ideally be shown that the service Rock Night is the service for which they are initiating a transaction by reading 100 the Objects 10, represented here as an event ticket and shown as a TID-Encoded Barcode 10A.

As covered in prior disclosures herein, subsequent to reading the Object 10 the Reader 20 may then process the TID data on the Reader 20 itself or Post the TID and other data to the Data Manager 30 or other remote servers for recording, tracking or validation purposes, depending on the actual application.

The embodiments of the invention in which an exclusive property or privilege is claimed are defined as follows:

1. A method to initiate and enable secure, real-time contactless transactions with a mobile device comprising: a) service profiles posted to the mobile device from a remote server based on the unique identity of the mobile device and mobile device user; b) the mobile device reading one or more type of data-embedded object presented at a point of service and representing a transaction; c) the mobile device appending to a data string user-entered or device-resident data to the data read from the object; d) the mobile device transmitting the resulting string of data to a remote server to facilitate a transaction; and, e) the mobile device receiving back from the remote server data representing the status of the transaction.

2. The method of claim 1 wherein the presented object read by the mobile device is a barcode.

3. The method of claim 1 wherein the presented object read by the mobile device is an image.

4. The method of claim 1 wherein the presented object read by the mobile device is a video.

5. The method of claim 1 wherein the presented object read by the mobile device is a short-range, wireless communication technology.

6. The method of claim 1 wherein the user of the mobile device selects in advance or at the point of service the object type to read.

7. The method of claim 1 wherein the mobile device senses the object type presented and automatically reads the object type presented.

8. The method of claim 1 wherein the transaction culminates in the consummation of, or attempted consummation of, an agreement between a buyer and seller to exchange an asset for payment.

9. The method of claim 1 wherein the transaction culminates in the transfer, exchange, recording, inspecting, correlating or verifying of information to achieve, or attempt to achieve, a specific purpose.

10. The method of claim 1 wherein the appended data does not require the unique identifiers of the mobile device user.

11. The method of claim 1 wherein the appended data does not include unique identifiers of the mobile device.

12. The method of claim 1 wherein the mobile device posts the data string to the remote server over the internet and the remote server posts the status data over the internet, each without opening a browser.

13. The method of claim 1 wherein the posted data is encrypted.

14. The method of claim 1 wherein the remote server posts a database to the mobile device; the database is stored on the mobile device; subsequent transaction data is stored on the mobile device; and the resulting database is posted back to the remote server.
